(19) United States
(12) Patent Application Publication
(10) Pub. No.: US 2005/0050988 A1
(43) Pub. Date: Mar. 10, 2005

(54) Fabricated eccentric shaft

(75) Inventor: Kenneth Sakichi Kondo, League City, TX (US)

Correspondence Address: CONLEY ROSE, P.C., P. O. BOX 3267, HOUSTON, TX, 77253-3267, US

(73) Assignee: National-Oilwell, L.P., Houston, TX (US)

(21) Appl. No.: 10/687,016

(22) Filed: Oct. 16, 2003

Related U.S. Application Data
(60) Provisional application No. 60/419,004, filed on Oct. 16, 2002.

(51) Int. Cl. F16C 3/04

(52) U.S. Cl. 74/595

(57) ABSTRACT

Methods and apparatus for constructing an eccentric shaft, characterized by a central shaft constructed of forged material and including one or more relatively small diameter eccentric protrusions to which are attached larger diameter discs shrink-fitted to the cylinder and suitable for interfacing with roller bearings. The ends of the central shaft are fitted with sleeves for interfacing with bearings that allow the shaft to rotate and preferably having one or more circumferential grooves for supplying a hydraulic assist in removing bearings from the shaft. The shaft also preferably has at least one concentric disc suitable for attaching to a gear through which power can be applied to rotate the shaft.

### CROSS-REFERENCE TO RELATED APPLICATIONS

The present application claims the benefit of U.S. Provisional Application Ser. No. 60/419,004, filed Oct. 16, 2002, entitled Fabricated Eccentric Shaft, which is incorporated herein by reference.

### STATEMENT REGARDING FEDERALLY SPONSORED RESEARCH OR DEVELOPMENT

Not applicable.

### TECHNICAL FIELD OF THE INVENTION

The present invention relates generally to eccentric shafts and methods for constructing eccentric shafts. More specifically, the present invention relates an improved eccentric shaft that is constructed primarily from forged components. Still more specifically, the present invention relates to an eccentric shaft constructed from primarily forged components that is suited for use in a large reciprocating pump.

### BACKGROUND OF THE INVENTION

Large reciprocating pumps are positive-displacement pumps often used to provide high pressure at a relatively low flow rate. These large pumps are normally provided as triples or quintuplex pumps having single- or double-acting plungers. These plungers are reciprocated by a rotating crankshaft where the plungers are mounted to the crankshaft on roller bearings. The crankshaft is mounted on a set of heavy bearings and is rotated by an external power source that transfers power to the crankshaft through a gear, or gear box.

The rotating crankshaft typically includes a central shaft onto which are formed an eccentric disc for each plunger. The eccentric discs normally have a much larger diameter than the central shaft and are oriented so that the plungers are timed in a desired manner. A concentric disc is also normally formed to the shaft and serves as the mounting flange for a gear that is used to rotate the shaft. Depending on the particular design of the pump, the crankshaft may have more than one concentric disc and as many eccentric discs as plungers.

These crankshafts have normally been constructed from a single casting, or weldment, so that the eccentric discs and concentric disc, or discs, are a single body. Because of the size of the assembly, it is difficult to obtain castings of sufficient quality and material characteristics that are suitable for long term, high stress applications. Welding components together has also proved undesirable due to the high costs and difficulties of designing and producing welds that will sustain large cyclical loading over a long period of time.

Thus, there remains a need in the art for a crankshaft that enables exhibiting increased fatigue life. Therefore, the embodiments of the present invention are directed to methods and apparatus for providing a crankshaft demonstrating improved life and performance characteristics that seek to overcome these and other limitations of the prior art.

### SUMMARY OF THE PREFERRED EMBODIMENTS

Accordingly, there are provided herein methods and apparatus for constructing an eccentric shaft. The embodiments of the present invention are characterized by a central shaft constructed of forged material and including one or more relatively small diameter eccentric protrusions to which are attached larger diameter discs suitable for interfacing with roller bearings. The ends of the central shaft are fitted with sleeves for interfacing with bearings that allow the shaft to rotate. The shaft also preferably has at least one concentric disc suitable for attaching to a gear through which power can be applied to rotate the shaft.

The larger diameter discs are preferably attached to the shaft by a combination of shrink-fitting and key cylinders that provide a stable, weld-free attachment mechanism. The sleeves on either end of the central shaft preferably have one or more circumferential grooves for supplying a hydraulic assist in removing bearings from the shaft.

Thus, the present invention comprises a combination of features and advantages that enable it to substantially increase the performance of an eccentric crankshaft. These and various other characteristics and advantages of the present invention will be readily apparent to those skilled in the art upon reading the following detailed description of the preferred embodiments of the invention and by referring to the accompanying drawings.

### BRIEF DESCRIPTION OF THE DRAWINGS

For a more detailed understanding of the preferred embodiments, reference is made to the accompanying Figures, wherein:

FIG. 1 is a side elevational view, partly in section, of an eccentric shaft constructed in accordance with the current invention;

FIG. 2 is a cross-sectional view through line II of FIG. 1; and

FIG. 3 partial sectional view of the end portion of the shaft of FIG. 1.

### DETAILED DESCRIPTION OF THE PREFERRED EMBODIMENTS

In the description that follows, like parts are marked throughout the specification and drawings with the same reference numerals, respectively. The drawing figures are not necessarily to scale. Certain features of the invention may be shown exaggerated in scale or in somewhat schematic form and some details of conventional elements may not be shown in the interest of clarity and conciseness.

The preferred embodiments of the present invention relate to methods and apparatus for providing an eccentric shaft having enhanced fatigue characteristics. The present invention is susceptible to embodiments of different forms. There are shown in the drawings, and herein will be described in detail, specific embodiments of the present invention with the understanding that the present disclosure is to be considered an exemplification of the principles of the invention, and is not intended to limit the invention to that illustrated and described herein. In particular, various embodiments of the present invention are described as shafts for a triplex pump having a single driving gear, but the use of the concepts of the present invention is not limited to triplex pumps or single driving gears and can be used for any other application in which an eccentric shaft is appropriate. It is to be fully recognized that the different teachings of the embodiments discussed below may be employed separately or in any suitable combination to produce desired results.

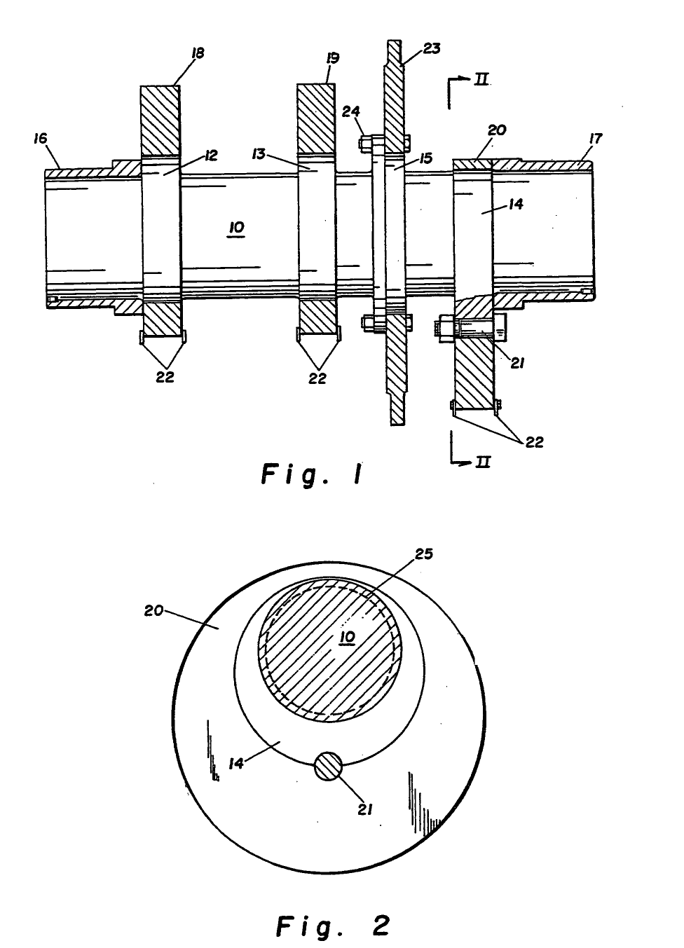

FIG. 1 shows, by way of example, an eccentric shaft suitable for use in a large triplex pumps. The shaft includes an elongated cylindrical body 10, a plurality of small eccentric discs 12, 13 and 14 extending radially from the body, and a relatively small diameter concentric gear flange 15, all formed as a single integral forging. The eccentric discs are spaced uniformly along the length of the shaft body and in the illustration the gear flange lies between discs 13 and 14. The junction between small eccentric discs 12, 13, and 14 and cylindrical body 10 is preferably shot-peened, or other wise processed, in order to enhance the fatigue life of the forging.

Relatively large eccentric discs 18, 19 and 20 are shrink-fitted on the small eccentric discs 12, 13 and 14 respectively. Bolts 21 extend through cutouts in the mating circumferential edges of the large and small discs to key the large discs to the small discs. Bolts 21 are installed and large eccentric discs 18, 19, and 20 are preferably shrink-fitted in a rough machined state, so that finish machine processing can take place once the components are assembled. At their outer circumferences the large discs carry retainers 22 for roller bearings (not shown) on which the connecting rods are pivoted. A driving gear carrier 23 is affixed to the gear flange 15, as with bolts 24. The gear flange and drive gear are omitted if the shaft is driven by other means. Other shafts may have more than one gear flange and drive gear.

FIG. 2 shows the relation between the diameters of discs 14 and 20. The relation is similar at the other discs. The path which the center of the larger disc 20 describes as the shaft rotates is referred to as the “crank circle” and is indicated at 25. According to the invention, the crank circle lies entirely within the small disc 14. The connecting rod load acts through the crank circle. As a consequence of the foregoing relation, the only torque transmitted through the shrink-fit is the small torque due to internal friction in the connecting rod bearings. As long as the shrink-fit is maintained, the bolt or key 21 transmits no torque, but serves only to locate the larger disc circumferentially with respect to the small disc.

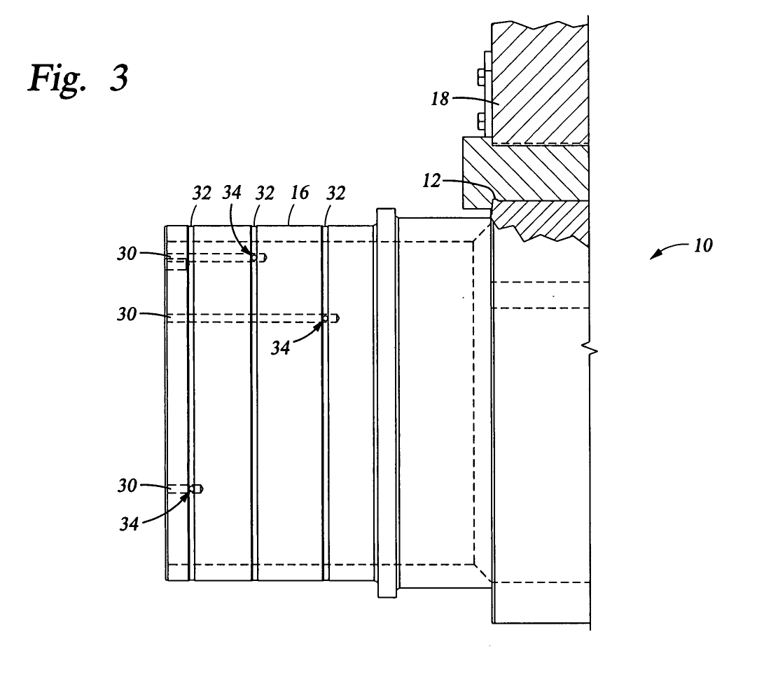

Sleeves 16 and 17 are fitted over the end portions of the shaft body outboard of the outermost discs 12 and 14 to be journaled in suitable bearings (not shown), and thus supporting the shaft for rotation on its longitudinal axis. As shown in FIG. 3, sleeves 16 and 17 preferably include hydraulic porting 30 that can be used to ease disassembly of the bearings. Porting 30 preferably includes one or more circumferential grooves 32 and corresponding lateral ports 34 that allow for the application of hydraulic fluid into the grooves in order to push a bearing off of the sleeve.

From the foregoing description, it is seen that the preferred embodiments provide an eccentric shaft of simple construction, preferably formed of a high-strength high-integrity forged alloy steel. The shaft easily can be inspected for defects by ultrasonic or other non-destructive methods. Shrink-fitting of the large eccentric discs eliminates any need for welding. Locating the key in the small disc eliminates stress concentration in the shaft as would be present if the large discs were keyed directly to the shaft.

The embodiments set forth herein are merely illustrative and do not limit the scope of the invention or the details therein. It will be appreciated that many other modifications and improvements to the disclosure herein may be made without departing from the scope of the invention or the inventive concepts herein disclosed. Because many varying and different embodiments may be made within the scope of the inventive concept herein taught, including equivalent structures or materials hereafter thought of, and because many modifications may be made in the embodiments herein detailed in accordance with the descriptive requirements of the law, it is to be understood that the details herein are to be interpreted as illustrative and not in a limiting sense.

1. An eccentric shaft comprising:
an elongated cylindrical body;
at least one small eccentric disc extending radially from said body;
at least one concentric gear flange extending radially from said body, said body, disc and flange being formed as a single integral forging;
a relatively large eccentric disc shrink-fitted and keyed to said small disc, the diameters of said discs being related that the center of said large disc describes a crank circle entirely within said small disc on rotation of said shaft; and
at least one sleeve affixed to said body, said sleeve comprising ports capable of transmitting fluid through a portion of said sleeve to an outer circumference of said sleeve.

2. A shaft as defined in claim 1 in which there are a plurality of said small discs spaced uniformly along the length of said shaft, and a corresponding member of large discs shrink-fitted and keyed to the small disc, said gear flange being located between two of said small discs.

3. A shaft as defined in claim 1 comprising in addition bearing retainers at the outer circumference of said large disc, the only torque on the shrink-fit being internal friction of bearings mounted in said retainers.

4. A shaft as defined in claim 1 in which a junction between the at least one small eccentric disc and elongated cylindrical body is stress-relieved.

5. A shaft as defined in claim 4 in which said junction is shot-peened.

6. An eccentric shaft comprising:
an elongated cylindrical body;
at least one small eccentric disc extending radially from said body;
at least one concentric gear flange extending radially from said body, said body, disc and flange being formed as a single integral forging;
a relatively large eccentric disc shrink-fitted and keyed to said small disc, the diameters of said discs being related that the center of said large disc describes a crank circle entirely within said small disc on rotation of said shaft; and
a junction between said disc and said body, said junction being stress-relieved.

7. A shaft as defined in claim 6 in which said junction is shot-peened.

8. A shaft as defined in claim 6 in which there are a plurality of said small discs spaced uniformly along the length of said shaft, and a corresponding member of large discs shrink-fitted and keyed to the small disc, said gear flange being located between two of said small discs.

9. A shaft as defined in claim 1 comprising in addition bearing retainers at the outer circumference of said large disc, the only torque on the shrink-fit being internal friction of bearings mounted in said retainers.

10. A shaft as defined in claim 6, further comprising at least one sleeve affixed to said body, said sleeve comprising ports capable of transmitting fluid through a portion of said sleeve to an outer circumference of said sleeve.
